(19) United States
(12) Patent Application Publication
(10) Pub. No.: US 2015/0092943 A1
(43) Pub. Date: Apr. 2, 2015

(54) DIGITAL DATA DISTRIBUTION SYSTEM

(71) Applicant: Strategy & Technology Limited, London (GB)

(72) Inventor: Nicholas Birch, Bristol (GB)

(21) Appl. No.: 14/502,931

(22) Filed: Sep. 30, 2014

(30) Foreign Application Priority Data
Oct. 1, 2013 (GB) 1317380.2

(51) Int. Cl. H04L 29/06; H04L 9/08

(52) U.S. Cl. CPC H04L 63/0457; H04L 9/083
USPC 380/279

(57) ABSTRACT

A digital data distribution system and method for distributing a digital data stream to consumer electronic devices is disclosed. The data distribution system is configured to distribute the same media information in a digital data stream to a plurality of consumer electronic devices. The digital data distribution system comprises at least one encrypter configured to encrypt a portion that is less than all and more than none of the same media information in the digital data stream in a different manner for at least a predetermined some that is less than all of the consumer electronic devices to form consumer encrypted data streams. A distributor is also provided to distribute each of the consumer encrypted data streams to its predetermined some consumer electronic devices, for example, over the Internet.

### CROSS-REFERENCE TO RELATED APPLICATIONS

This application claims priority to British Application No. GB 1317380.2, filed on Oct. 1, 2013, entitled “A DIGITAL DATA DISTRIBUTION SYSTEM,” which is incorporated herein by reference in its entirety.

### BACKGROUND

1. Technological Field

The disclosed technology relates to a digital data distribution system, a digital data distribution method, and an encrypter.

2. Description of the Related Technology

Digital media is often distributed in encrypted form to enable management of the access to the media. Known encryption processes and subsequent decryption processes are very computationally expensive. Typically, they use a key to encrypt and then decrypt the media. If the media is encrypted once using a key and then read by multiple consumers using the same key it is, therefore, important to protect the key for that media. If the system is compromised such that the key is revealed then any party that can access the encrypted media can decrypt it.

### SUMMARY OF CERTAIN INVENTIVE ASPECTS

Embodiments of the disclosed technology provide an efficient method for encrypting digital media with diverse encryption configurators, such as keys. They provide efficient implementation of key diversity for content protection of internet delivered media. They also provide good content protection. The inventor of the disclosed technology has appreciated that when media data is delivered via the internet there is an opportunity to encrypt the data differently for each consumer or group of consumers.

Embodiments of the disclosed technology described herein make it practical to encrypt a single piece of media in many different ways. This enables data encrypted in a particular way, for example, with a particular set of cryptographic keys to be sent to just one consumer (or a small population of consumers). This key diversity greatly reduces the consequences of key disclosure or access to the encrypted media.

An embodiment of the disclosed technology is provided by a system for partitioning the encryption of a media data so that the majority of the data is encrypted once and a minority of the data encrypted for a specific consumer (or small population of consumers) such that the computational cost of the encryption per consumer is low.

An embodiment of the disclosed technology is provided by a system where the media data is partially or wholly encrypted prior to movement or storage within a distribution network before final encryption for delivery to the consumer to provide security of the media data while moved or stored within the distribution network. For example, the digital data stream is at least in part encrypted forming a distribution network stream before being encrypted by the at least one encrypter. For example, the distribution network stream is moved or stored within the digital distribution system without distribution to consumer electronic devices.

An embodiment of the disclosed technology is provided by a system where the encryption keys for user specific encryption are created close to the place and time where the user specific encryption is applied to media data and then communicated to the consuming device simplifying and securing these keys and their use by the encrypting and securing devices. For example, at least one encryption key of the at least one encrypter is created at a consumer electronic device interfacing portion of the digital distribution system. For example, at least one encryption key of the at least one encrypter is created on request or expected request of a consumer electronic device. The proximity of the key generation removes the need for secure storage and communication between subsystems; it is a transient state that is only communicated to the relevant consumer equipment.

The disclosed technology in its various aspects is defined in the independent claims below to which reference should now be made. Advantageous features are set forth in the dependent claims.

Arrangements are described in more detail below. One aspect of the disclosed technology includes a digital data distribution system for distributing a digital data stream to consumer electronic devices, configured to distribute the same media information in a digital data stream to a plurality of consumer electronic devices 230, 240, 520. The digital data distribution system comprises at least one encrypter 221, 222, 513. The at least one encrypter 221, 222, 513 is configured to encrypt a portion that is less than all and more than none of the same media information in the digital data stream in a different manner for at least a predetermined some that is less than all of the consumer electronic devices 230, 240, 520 to form consumer encrypted data streams. A distributor is also provided to distribute each of the consumer encrypted data streams to its predetermined some consumer electronic devices. For some implementations, the distributor distributes the consumer encrypted data streamover the Internet.

Another aspect of the disclosed technology includes a digital data distribution method for distributing a digital data stream to consumer electronic devices, the method comprising distributing the same media information in a digital data stream to a plurality of consumer electronic devices. The digital data distribution method comprises encrypting a portion that is less than all and more than none of the same media information in the digital data stream in a different manner for at least a predetermined some that is less than all of the consumer electronic devices to form consumer encrypted data streams. The digital data distribution method further comprises distributing each of the consumer encrypted data streams to its predetermined some consumer electronic devices.

A computer program can be used to implement the digital data distribution method. A computer-readable medium containing a set of instructions that causes a computer to carry out the digital data distribution method can store the program.

Another aspect of the disclosed technology provides an encrypter for encrypting a digital data stream for distributing a digital data stream to consumer electronic devices. The encrypter is configured to encrypt a portion that is less than all and more than none of the same media information in a digital data stream in a different manner for at least a predetermined some that is less than all of a set of consumer electronic devices to form consumer encrypted data streams.

Another aspect of the disclosed technology includes a digital data distribution system for distributing a digital data stream to consumer electronic devices, configured to distribute the same media information in a digital data stream to a plurality of consumer electronic devices. The digital data distribution system comprises means for encrypting a portion that is less than all and more than none of the same media information in the digital data stream in a different manner for at least a predetermined some that is less than all of the consumer electronic devices to form consumer encrypted data streams. The digital data distribution system further comprises means for distributing each of the consumer encrypted data streams to its predetermined some consumer electronic devices.

### BRIEF DESCRIPTION OF THE DRAWINGS

The disclosed technology will be described in more detail by way of example with reference to the accompanying drawings, in which:

FIG. 1 is a schematic diagram illustrating the structure of an MPEG Transport Stream packet emphasizing the Transport Scrambling Control bits;

FIG. 2 is a schematic diagram illustrating a system embodying an example of the disclosed technology;

FIG. 3 is a schematic diagram illustrating a variant of the example of FIG. 2 (FIG. 2 is representative of a video on demand (VoD) system which handles video files; FIG. 3 is representative of a system handling video streams);

FIG. 4 is a schematic diagram illustrating a variant of the FIG. 1 where all the media data is encrypted within the distribution network;

FIG. 5 is a schematic diagram illustrating a variant where the consumer specific key is generated close to where the consumer specific encryption is performed and from there communicated directly to the consumer equipment; and

FIG. 6 is a flowchart illustrating a method for distributing a digital data stream to consumer electronic devices according to the disclosed technology.

### DETAILED DESCRIPTION OF CERTAIN ILLUSTRATIVE EMBODIMENTS

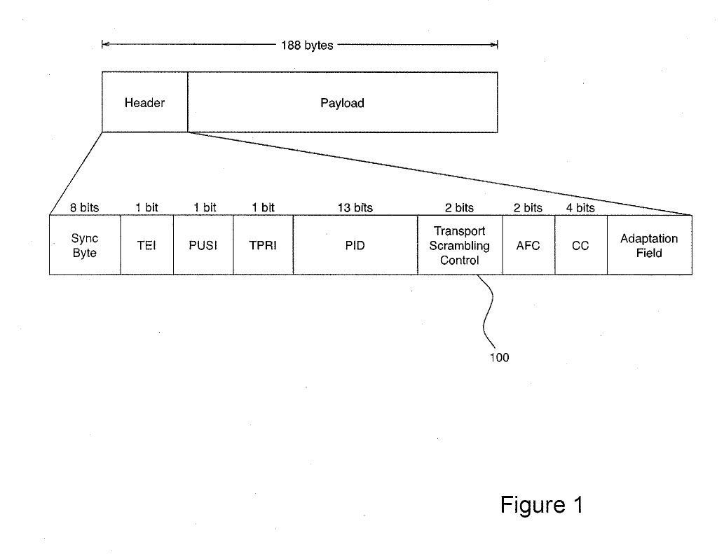

A digital data distribution system, a digital data distribution method, an encrypter, a computer program, and a computer-readable medium embodying aspects of the disclosed technology will now be described with reference to FIGS. 1 to 6.

Digital media formats typically provide signalling to allow different encryption keys to be used on different parts of the media. In a broadcast context this allows the encryption keys to be changed over time. For example, packets of MPEG Transport Streams, as defined in ISO/IEC 13818-1, have a 2 bit Transport Scrambling Control field 100 (FIG. 1). Other standards such as ETSI TS 100 289 define semantics of the values for these bits: no encryption; encryption with “even” key; encryption with “odd” key.

More generally the signalling may be described as a key index where the key index identifies the encryption key applicable to an item of media data. The disclosed technology is applicable where the media format supports a choice of at least 2 different encryption keys.

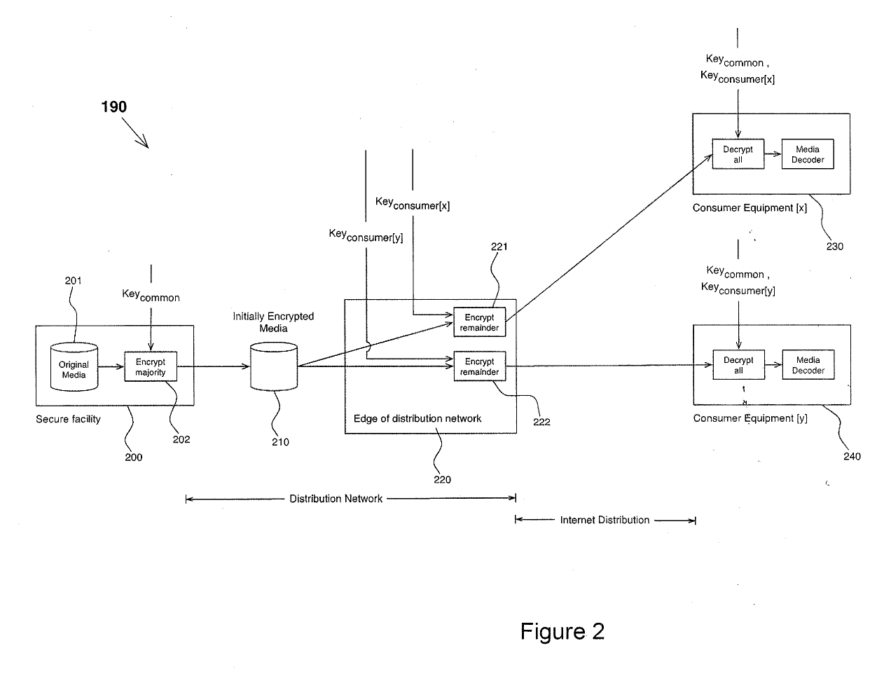

A first embodiment of the disclosed technology is illustrated in FIG. 2 and illustrates a digital data distribution system 190. This first embodiment illustrates the application of the disclosed technology to media on demand. A secure facility 200 has a source of media data files 201 and an encryption function 202. The encryption function 202 is configured to encrypt the majority of the media data with an encryption key designated KeyCommon. The media data once processed in 200 can be stored in a store 210 until demanded by a consumer or a consumer electronic device such as a set-top box, a computer, a telephone such as a smart phone, or a television such as a smart television.

When a consumer operating Consumer Equipment [x] 230 or a consumer electronic device demands data this is processed by functions logically at the edge of the distribution network 220 before delivery to the Consumer Equipment 230. At 221 this processing includes encryption of some or all of the media data not encrypted previously by the encryption function or encrypter 202. This encryption or encrypter at 221 uses an encryption key designated KeyConsumer[x].

The data emitted from encrypter 221 is encrypted with at least two different encryption strategies. Each encryption strategy is enabled by an encryption configurator. Each encryption configurator may be, for example, an encryption key or an encryption initialisation vector. In this example, each of two different encryption strategies are by implemented by a different encryption configurator in the form of a different encryption key. The majority of the data is encrypted with the key designated KeyCommon (a key common to all consumers or users) and a smaller part of the data encrypted with the key designated KeyConsumer[x] (a key specific to each consumer or selected consumers). The smaller part or portion may be 20% or less and more than none of the same media information, 10% or less and more than none of the same media information, less than all and 2% or more of the same media information, between 20% and 2% of the same media information, or between 10% and 2% of the same media information. Signalling in the data indicates which key applies to which portion of data. Where the media data is moving picture information such as MPEG Transport Stream data the Transport Scrambling Control bits are used to signal the encryption key used. For example, the Transport Stream packets encrypted with the KeyCommon at 202 could have their Transport Scrambling Control bits set to “odd” key and the packets encrypted with the consumer specific key KeyConsumer[x] at 221 could have their Transport Scrambling Control bits set to “even” key. Packets emitted un-encrypted from the first encryption 202 have their Transport Scrambling Control bits set to indicate not encrypted. This allows the consumer specific encryption 221 to identify packets that have not been encrypted at 202 and thus are candidates for encryption at 221.

Two encryption keys KeyCommon and KeyConsumer[x] are securely supplied to Consumer Equipment [x] 230 these allow the media data to be decrypted.

A second consumer operating Consumer Equipment [y] 240 demands the same data. In this case a second encryption function 222 encrypts some or all of the media data not encrypted previously by 202 with a different encryption key designated KeyConsumer[y].

This disclosed technology uses a unique set of encryption keys for each consumer. However, as only a small proportion of the media data is encrypted with a consumer specific key the computational cost for that consumer is much lower than if all of the data was encrypted specifically for that consumer.

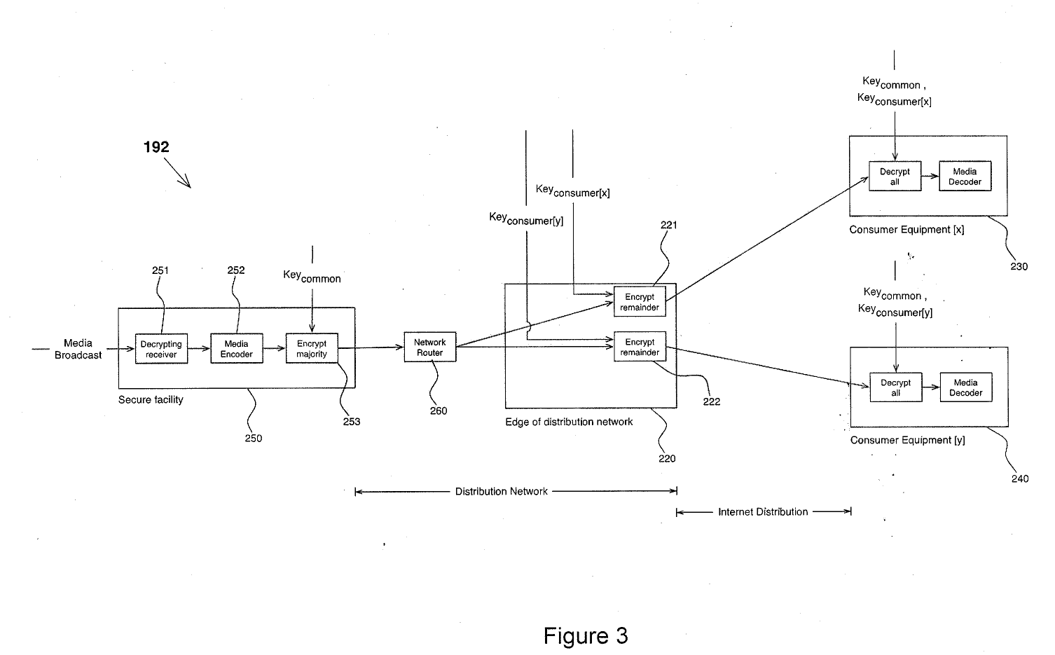

A second embodiment of the disclosed technology is illustrated in FIG. 3 and illustrates a digital data distribution system 192. The embodiment of FIG. 3 is similar in many respects to the embodiment of FIG. 2 and like features have been given like reference numerals. This second embodiment illustrates streaming of media data. Here media data is received at a secure location 250. For example, a broadcast signal is received via a decrypting professional receiver 251 and then re-encoded via a media encoder 252. This media encoder supplies media data to the encryption function 253. This encryption function 253 serves the same roles as the encryption function 202 in FIG. 2.

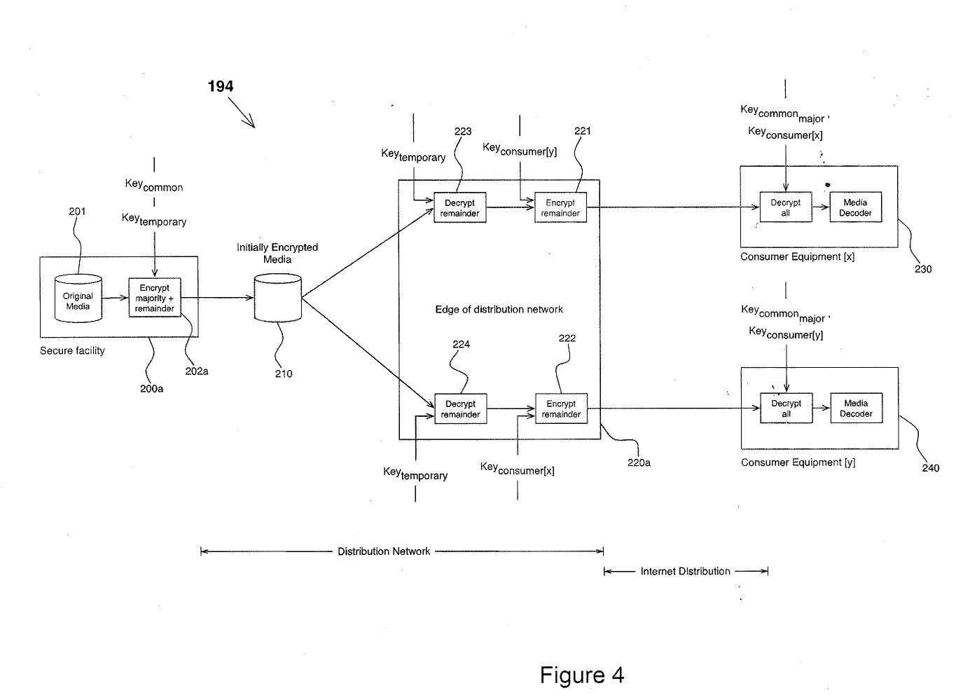

A third embodiment of the disclosed technology is illustrated in FIG. 4 and illustrates a digital data distribution system 194. The embodiment of FIG. 4 is similar in many respects to the embodiment of FIGS. 2 and 3 and like features have been given like reference numerals. This is a modification of the first embodiment. In this variant at the first encryption 202a the media data left unencrypted in 202 is instead encrypted with an encryption key designated KeyTemporary. The signaling of the encryption key used on this data is set to complement that used for the data encrypted with the encryption key designated KeyCommon. For example, where the media data is MPEG Transport Stream the Transport Stream packets encrypted with the KeyCommon at 202a could have their Transport Scrambling Control bits set to “odd” key and the packets encrypted with the temporary key KeyTemporary could have their Transport Scrambling Control bits set to “even” key.

In FIG. 4 when a consumer operating Consumer Equipment [x] 230 demands data this is processed by functions logically at the edge of the distribution network 220a before delivery to the Consumer Equipment 230. A decryption function 223 decrypts the data encrypted with the encryption key, a temporary key, designated KeyTemporary before some or all of the unencrypted data is encrypted 221 with the encryption key designated KeyConsumer[x] (a key specific to a user, a consumer or a group of consumers). This embodiment allows the media data passing from 200a to 220a to be completely encrypted at the expense of a small increase in computational cost in 220a compared to 220 in FIG. 1.

The encryption algorithm used with the temporary key can be different from that specified for final delivery to the consumer equipment as this encryption is local between 200a and 220a. For example, DES (date encryption standard) could be used rather than AES (advanced encryption standard) to reduce the computational cost of the decryption in 220a.

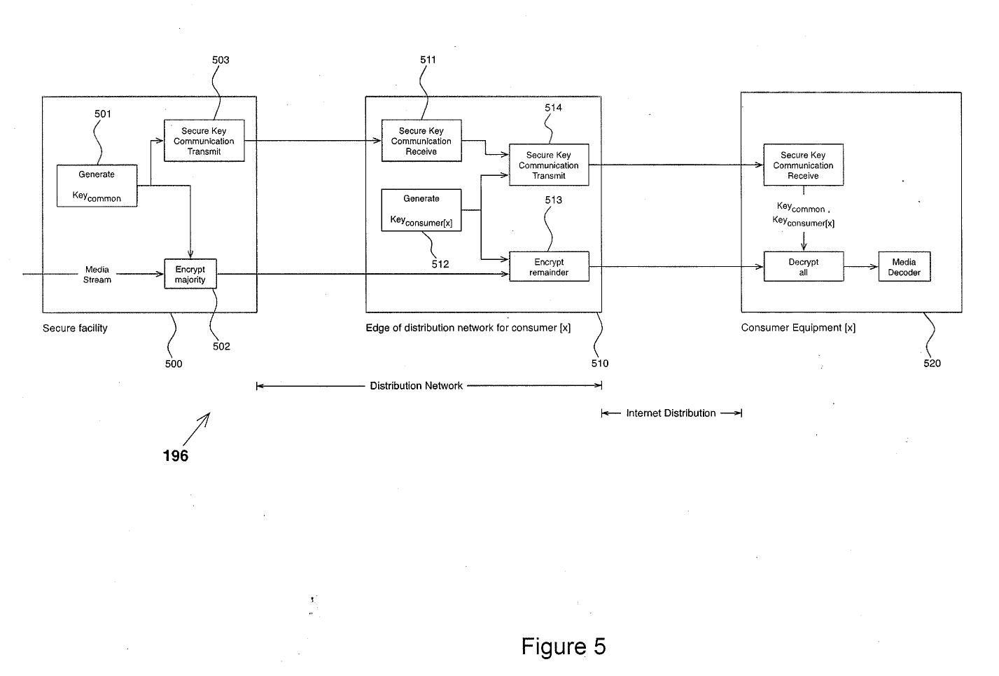

A fourth embodiment of the disclosed technology is illustrated in FIG. 5, which illustrates a digital data distribution system 196. In the secure facility 500 the encryption key designated KeyCommon (an encryption key common to all consumers or users) is generated locally 501 and supplied to an encryption function 502 where the key is used to encrypt the majority of the media data. This key is also communicated securely 503 to the functions logically at the edge of the network where consumer specific data processing is performed 510. This securely communicated key is received 511. A consumer specific encryption key designated KeyConsumer[x] is generated 512. This is used by the consumer specific encryption function 513 to encrypt some or all of the media data not encrypted previously by 502. The encryption keys designated KeyCommon and KeyConsumer[x] are securely communicated 514 to the consumer equipment 520. A secure communications channel such as TLS (Transport Layer Security defined in RFC 5246) with client and server authentication can be used for the secure key communication.

In this fourth embodiment the consumer specific key only needs to be known to the edge of network processing 510 particular to the specific consumer and to the particular consumer equipment 520. Also, this key only needs to exist for the duration of the session between this edge of network processing and the particular consumer equipment. This simplifies and secures the handling of the consumer specific key as the key does not need to be handled or stored by other systems.

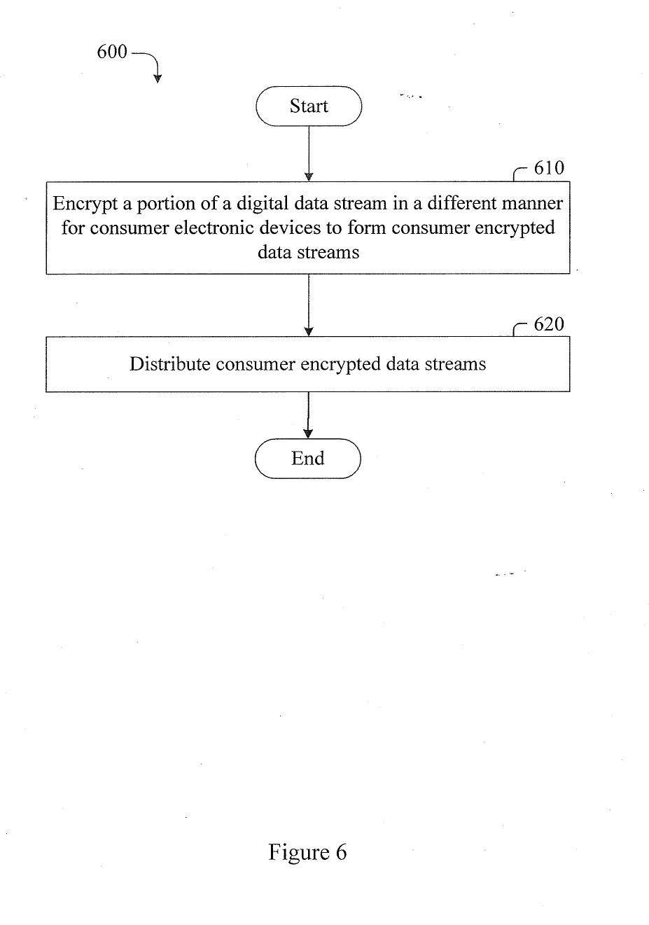

A digital data distribution method using the embodiments depicted in FIGS. 1-5 will now be described with respect to FIG. 6, which is a flowchart illustrating a method 600 for distributing a digital data stream to consumer electronic devices. At block 610, method 600 encrypts a portion of a digital data stream in a different manner for consumer electronic devices to form consumer encrypted data streams 220, 221. At block 620, method 620 distributes consumer encrypted data streams 510.

The disclosed technology has been described above with reference to one or more embodiments thereof. It should be understood that various modifications, alternations and additions can be made to the device structure by one skilled person in the art without departing from the spirits and scope of the disclosed technology. Moreover, the teachings of the present disclosure may make various modifications which may be adapted for particular situations or materials without departing from the spirits and scope of the disclosed technology. Therefore, the object of the disclosed technology is not limited to the above particular embodiments. The device structure and the manufacture method thereof as disclosed will include all of embodiments falling within the scope of the disclosed technology disclosed technology disclosed technology.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure, such as encryption, may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a digital data distribution system, encrypter, and/or consumer electronic device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A digital data distribution system for distributing a digital data stream to consumer electronic devices, the system being configured to distribute the same media information in a digital data stream to a plurality of consumer electronic devices, the digital data distribution system comprising:
at least one encrypter, wherein the at least one encrypter is configured to encrypt a portion that is less than all and more than none of the same media information in the digital data stream in a different manner for at least a predetermined some that is less than all of the consumer electronic devices to form consumer encrypted data streams; and
a distributor to distribute each of the consumer encrypted data streams to its predetermined some consumer electronic devices.

2. The digital data distribution system according to claim 1, wherein the portion is 20% or less and more than none of the same media information.

3. The digital data distribution system according to claim 1, wherein the portion is 10% or less and more than none of the same media information.

4. The digital data distribution system according to claim 1, wherein the portion is less than all and 2% or more of the same media information.

5. The digital data distribution system according to claim 1, wherein the portion is between 20% and 2% of the same media information.

6. The digital data distribution system according to claim 1, wherein the portion is between 10% and 2% of the same media information.

7. The digital data distribution system according to claim 1, wherein the digital data stream comprises moving picture information.

8. The digital data distribution system according to claim 7, wherein the digital data stream comprises an MPEG transport stream.

9. The digital data distribution system according to claim 1, wherein the media information comprises a payload of the digital data stream.

10. The digital data distribution system according to claim 1, wherein the media information does not comprise a header of the digital data stream.

11. The digital data distribution system according to claim 1, wherein the portion of the digital data stream that is not the portion that is less than all and more than none of the same media information is encrypted at least in part in the same manner for all of the consumer electronic devices.

12. The digital data distribution system according to claim 1, wherein the portion of the digital data stream that is not the portion that is less than all and more than none of the same media information is encrypted in the same manner for all of the consumer electronic devices.

13. The digital data distribution system according to claim 1, wherein the digital data stream comprises digital media data on demand.

14. The digital data distribution system according to claim 1, wherein the predetermined some that is less than all of the consumer electronic devices comprises one of the consumer electronic devices.

15. The digital data distribution system according to claim 1, wherein the digital data stream is at least in part encrypted forming a distribution network stream before being encrypted by the at least one encrypter.

16. The digital data distribution system according to claim 15, wherein the distribution network stream is moved or stored within the digital distribution system without distribution to consumer electronic devices.

17. The digital data distribution system according to claim 1, wherein at least one encryption configurator of the at least one encrypter is created at a consumer electronic device interfacing portion of the digital distribution system.

18. The digital data distribution system according to claim 1, wherein at least one encryption configurator of the at least one encrypter is created on request or expected request of a consumer electronic device.

19. The digital data distribution system according to claim 17, wherein the at least one encryption configurator comprises an encryption key and/or an encryption initialisation vector.

20. The digital data distribution system according to claim 18, wherein the at least one encryption configurator comprises an encryption key and/or an encryption initialisation vector.

21. The digital data distribution system according to claim 1, wherein the consumer electronic device comprises a set-top box, a computer, a telephone, a smart phone, a television, or a smart television.

22. The digital data distribution system according to claim 1, wherein the distributor distributes each of the consumer encrypted data streams to its predetermined some consumer electronic devices over the Internet.

23. A digital data distribution method for distributing a digital data stream to consumer electronic devices, the method comprising distributing the same media information in a digital data stream to a plurality of consumer electronic devices, the digital data distribution method comprising:
encrypting a portion that is less than all and more than none of the same media information in the digital data stream in a different manner for at least a predetermined some that is less than all of the consumer electronic devices to form consumer encrypted data streams; and
distributing each of the consumer encrypted data streams to its predetermined some consumer electronic devices.

24. An encrypter for encrypting a digital data stream for distributing a digital data stream to consumer electronic devices, wherein the encrypter is configured to encrypt a portion that is less than all and more than none of the same media information in a digital data stream in a different manner for at least a predetermined some that is less than all of a set of consumer electronic devices to form consumer encrypted data streams.

25. A digital data distribution system for distributing a digital data stream to consumer electronic devices, the system being configured to distribute the same media information in a digital data stream to a plurality of consumer electronic devices; the digital data distribution system comprising:
means for encrypting a portion that is less than all and more than none of the same media information in the digital data stream in a different manner for at least a predetermined some that is less than all of the consumer electronic devices to form consumer encrypted data streams; and
means for distributing each of the consumer encrypted data streams to its predetermined some consumer electronic devices.

26. The digital data distribution system according to claim 25, wherein the encrypting means comprises at least one encrypter; and wherein the distribution means comprises at least one distributor.
